(19) United States
(12) Patent Application Publication
(10) Pub. No.: US 2012/0194124 A1
(43) Pub. Date: Aug. 2, 2012

(54) Wireless Battery Charging System

(75) Inventors: Timo Toivola, Turku (FI); Juha Oskari Hautala, Lieto (FI)

(73) Assignee: Nokia Corporation

(21) Appl. No.: 13/017,185

(22) Filed: Jan. 31, 2011

(51) Int. Cl. H02J 7/00

(52) U.S. Cl. 320/108

(57) ABSTRACT

In accordance with the exemplary embodiments of the invention there is at least a method, apparatus, and executable computer program to perform operations including transferring power received at a coil of a wireless charging receiver to a wireless receiver block of the wireless charging receiver, the transferred power being used to provide a charge to a portable device attached to the wireless charging receiver, receiving a signal from the portable device, the signal comprising an indication that the portable device no longer requires the charge, and in response to the signal, automatically opening a connection between the coil and the wireless receiver block to stop the transferring of the power. Further in accordance with the exemplary embodiments of the invention there is determining at a portable device that a charging current received over a particular type of charging interface from a wireless charging receiver is no longer required, and in response to the determining, the portable device modifying a data transaction signal associated with the particular type of charging interface and sending the modified data transaction signal to the wireless charging receiver to indicate to the wireless charging receiver that the charging current is no longer required.

### TECHNICAL FIELD

The teachings in accordance with the exemplary embodiments of this invention relate generally to wireless charging and, more specifically, relate to controlling wireless charging power consumption based on a status or charging state of a device in order to minimize standby power waste and increase energy efficiency.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Wireless charging has become more and more popular with the main benefit being ease of use. If the device that is to be charged doesn't have a wireless charging receiver built in to it then the device can be equipped with sleeve or similar structure which contains a small wireless charging receiver. This sleeve or similar structure can be connected directly to a charging socket of the device. When the device no longer requires a charge the charging transmitter typically enters a standby mode or a sleep mode. In this standby mode the power consumption of the charging transmitter is generally reduced. However, the main power source of the transmitter, such as a transformer, will remain continually powered.

According to USB charging interface specifications, a device can be charged if DC power is provided to its USB charging socket. Therefore, to charge the device a wireless charging receiver, such as the sleeve, uses a DC converter to supply DC power to the USB charging socket of the device. This operation works more efficiently when almost all of the transferred power is being supplied to the device battery. Then when the charging receiver is taken away the charging transmitter can detect this and go into the standby mode where the output power of the charging transmitter is reduced. The charging transmitter then starts testing from time to time in order to determine if the wireless charging receiver, or its magnetic field, has re-appeared in which case the full charging power of the charging transmitter will resume.

The USB charging specifications also define two current levels that the host/root hub or hub must support, i.e. one unit load (100 mA) and five unit loads (500 mA). In order to charge a battery in battery powered equipment, a high current may be needed. If the current capabilities of the charger match or are below the device capabilities, the device may begin charging the battery. Charging may be discontinued if the supplied current as provided by the charger is not sufficient.

A problem that exists with conventional chargers is that when a device is no longer charging, or has been fully charged but is still connected in some manner to the transmitter, the transmitter is still utilizing power. This can occur regularly such as when a user of the device is no longer using the device and it is left to charge for extended periods of time, (e.g., during the night). Further, in this situation the charging sleeve or similar structure is unaware of when the device may need to be charged again. Therefore, the sleeve or similar structure continues to draw power without charging the device. In addition, the charging transmitter also continues to supply power to the sleeve all the time, thereby consuming power from the main source.

Therefore, a need exists to better control a charging receiver so that power utilized by the wireless charging system and/or its components is at a minimum when a device is no longer accepting a charge, or is fully charged. In addition, a need exists to enable a charging receiver in a standby mode to be able to detect a need to resume charging of the device and to leave the standby mode to resume the charging of the device.

### SUMMARY

In an exemplary aspect of the invention, there is a method comprising transferring power received at a coil of a wireless charging receiver to a wireless receiver block of the wireless charging receiver, the transferred power being used to provide a charge to a portable device attached to the wireless charging receiver, receiving a signal from the portable device, the signal comprising an indication that the portable device no longer requires the charge, and in response to the signal, automatically opening a connection between the coil and the wireless receiver block to stop the transferring of the power.

In an exemplary aspect of the invention, there is an apparatus comprising at least one processor, and at least one memory including computer program code, where the at least one memory and the computer program code are configured, with the at least one processor, to cause the apparatus to at least transfer power received at a coil of a wireless charging receiver to a wireless receiver block of the wireless charging receiver, the transferred power being used to charge a portable device attached to the wireless charging receiver, receive a signal from the portable device, the signal comprising an indication that the portable device no longer requires the charge, and in response to the signal, automatically open a connection between the coil and the wireless receiver block to stop the transferring of the power.

In another exemplary aspect of the invention, there is a method comprising determining at a portable device that a charging current received over a particular type of charging interface from a wireless charging receiver is no longer required, and in response to the determining, the portable device modifying a data transaction signal associated with the particular type of charging interface and sending the modified data transaction signal to the wireless charging receiver to indicate to the wireless charging receiver that the charging current is no longer required.

In still another exemplary aspect of the invention, there is an apparatus comprising at least one processor, and at least one memory including computer program code, where the at least one memory and the computer program code are configured, with the at least one processor, to cause the apparatus to at least determine at a portable device that a charging current received over a particular type of charging interface from a wireless charging receiver is no longer required, and in response to the determining, modify a data transaction signal associated with the particular type of charging interface and send the modified data transaction signal to the wireless charging receiver to indicate to the wireless charging receiver that the charging current is no longer required.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 illustrates a portable device attached to a wireless charging receiver electrically connected to a wireless charging transmitter and power supply;

FIG. 2 illustrates a basic circuit design of a wireless charging receiver and identifies a wireless charging transmitter and power supply;

FIG. 3 illustrates an example circuit design of a wireless charging receiver in accordance with the embodiments of the invention;

FIG. 4 illustrates another circuit design of a wireless charging receiver in accordance with the embodiments of the invention and identifies circuit components which operate in accordance with the embodiments;

FIG. 5 is a pictorial view of charging system including a power supply, a wireless charging transmitter, a wireless charging receiver sleeve, and a cellular phone which uses the charging system;

FIGS. 6 and 7 are each a logic flow diagram that illustrates the operation of a method and a result of execution of computer program instructions embodied on a non-transitory computer readable memory, in accordance with the exemplary embodiments of this invention;

FIG. 8 recreates FIG. 3.11 of the USB Battery Charging Specification Revision 1.2 Dec. 7, 2010; and a

FIG. 9 illustrates charging signaling in accordance with the embodiments of the invention as applied to FIG. 3.11 of the USB Battery Charging Specification Revision 1.2 Dec. 7, 2010

### DETAILED DESCRIPTION

Different charging devices can be used with different portable electronic devices. Some of these charging devices can utilize wireless connectivity/functionality such as between a wireless charging transmitter and a wireless charging receiver. The charging receiver is connected in some manner to a portable electronic device which is to be charged. The portable electronic device can be charged by connecting it to the charging receiver via a port, for example a universal serial bus (USB) port. The charging receiver may be a module that wirelessly connects to a charging transmitter which is powered by a power supply such as a transformer. The wireless charging receiver then provides a charging current to the device, such as through the USB port to the portable electronic device. The requirements for battery charging and charger detection using a USB port are described in USB Battery Charging Specification Revision 1.2 Dec. 7, 2010. This document may be found at http://www.usb.org.

An exemplary embodiment of the invention provides better control of a wireless charging receiver and a wireless charging transmitter so that power utilization by the wireless charging system is at a minimum or turned off when a device is no longer accepting a charge or is fully charged.

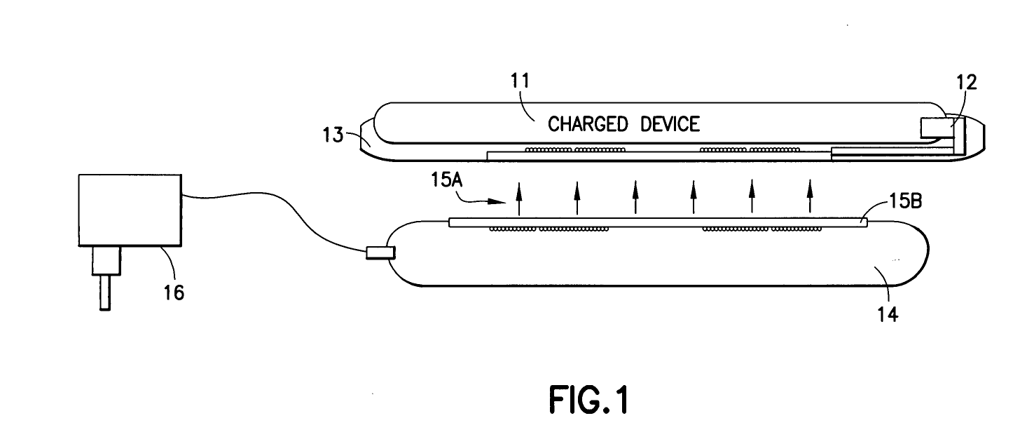

In FIG. 1 there is illustrated a wireless charging system to charge a portable device. As illustrated in FIG. 1 a portable device 11 is linked to a wireless charging receiver 13. In this case the wireless charging receiver 13 is illustrated as a sleeve. However, the wireless charging receiver 13 may be another type of device that attaches to the portable device to be charged. A charging transmitter 14 is powered by a transformer 16 and the charging transmitter 14 provides power to the wireless charging receiver 13 using inductive or electro magnetic energy via coils 15A and a platform pad 15B.

It will be understood that, as illustrated in FIG. 1, the portable device 11 and the charging receiver 13 are linked via a direct current (DC) universal serial bus (USB) charging interface 12 established between the portable device 11 and the wireless charging receiver 13. The wireless charging receiver 13 may provide charging of the portable device 11 by providing power, such DC power, to the portable device 11 via the charging interface 12.

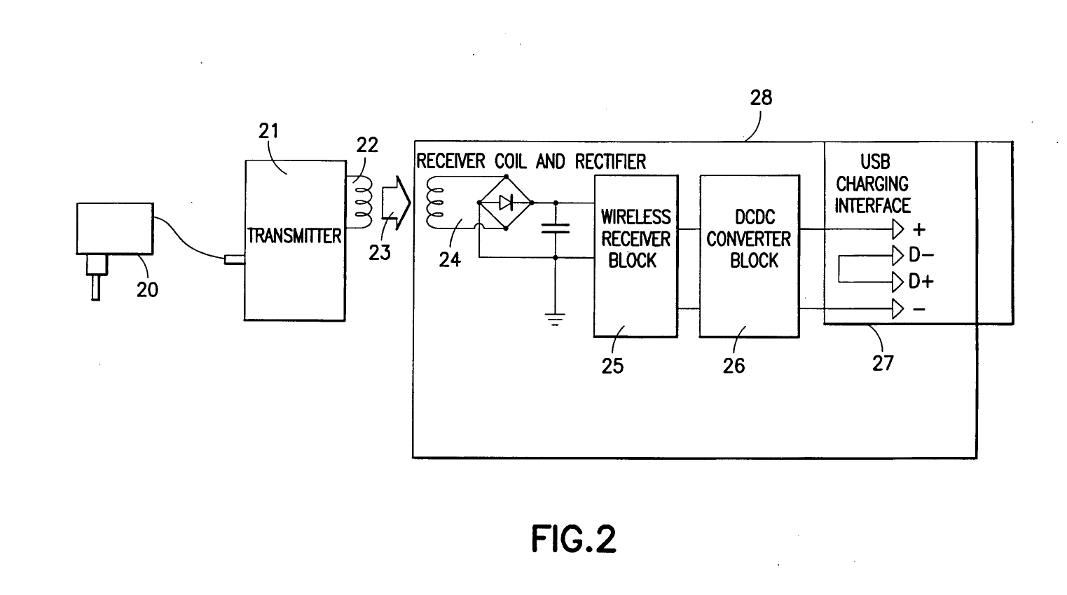

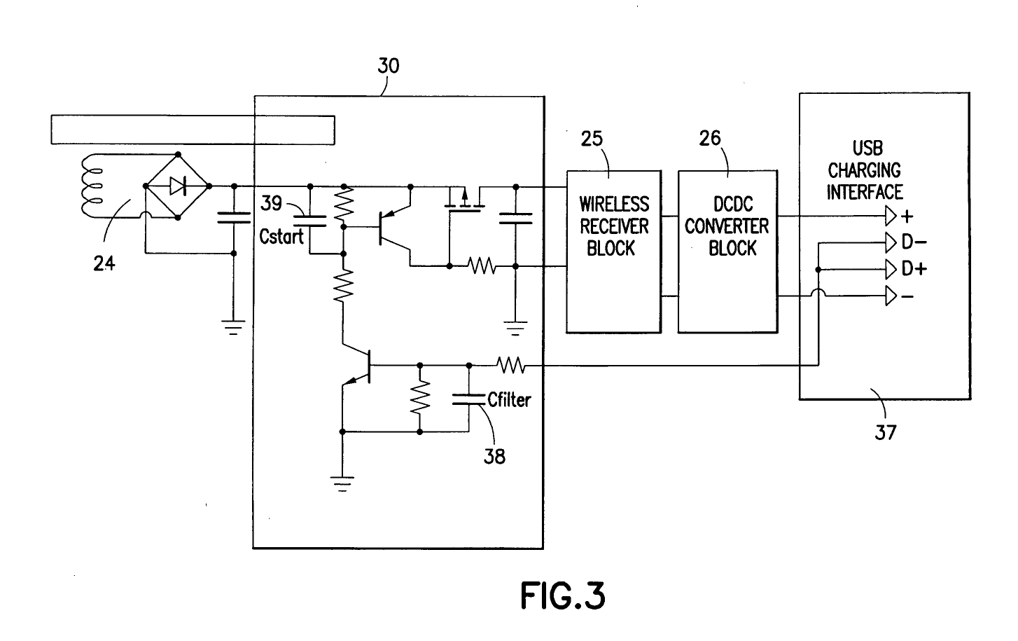

FIG. 2 illustrates a simple component schematic of a wireless charging system. In FIG. 2 there is a wireless charging transmitter 21 which is powered by a transformer 20. The wireless charging transmitter 21 transmits electro magnetic energy 23 from a coil 22 of the wireless charging transmitter 21 to a coil and rectifier 24 shown collectively as the coils 15A of FIG. 1. The wireless charging receiver 28 includes a wireless receiver block 25 which processes power transferred to it from the coil and rectifier 24 and provides the power to a DC-DC converter block 26. The DC-DC converted power is provided to a USB charging interface 27 as a charging current for charging a device attached to the charging interface 27. The charging interface 27 provides the charging current to the device. The interface 27 may also receive data signals from the device and these data signals may be used to control whether the charging current is sent to the device via the charging interface 27 as detailed below with regards to FIG. 3.

The exemplary aspects of the invention include but are not limited to the following:
A wireless charging receiver 28, which may be contained in a sleeve, includes the receiver coil 24 and the DC-DC converter 26 which supplies power to a charging interface 27, such as a USB power interface of a portable electronic device.
When the device is fully charged, it causes the power from the receiver coil 24 to automatically be switched off by sending a signal, such as a DC signal, via the interface. This signal can be sent continuously.
When the power from the receiver coil 24 is switched off it effectively leaves the receiver coil 24 open causing the charging transmitter 21 to go into a sleep mode where it starts sniffing for the receiver coil 24.
When the device requires charging, it stops sending the signal and the power from the receiver coil 24 is switched on.

Disclosed is a method for increasing efficiency of wireless charging using a structure, such as a sleeve, connected to a device to be charged. The wireless charging receiver 28 contains the receiver coil 24 and DC-DC converter 26 which supplies power to the charging interface 27 attached to the device to be charged. In accordance with the exemplary embodiments of the invention, at least one of hardware and software is provided which enables the wireless charging system to use less power than the conventional wireless charging systems.

In accordance with some exemplary embodiments of the invention, when a portable electronic device is fully charged, power from the receiver coil 24 which is being transferred to a wireless receiver block 25 in the wireless charging receiver 28 is switched off. More, specifically a connection is opened between the receiver coil 24 and the wireless receiver block 25 to stop any transferring of power. This operation is performed in response to a “no need to charge” type signal received from the portable electronic device attached to the charging interface 27 of the wireless charging receiver. This “no need to charge” type signal may be a transaction signal. Further, when the power from the receiver coil 24 being transferred to the wireless receiver block 25 is switched off this also causes the charging transmitter 21 to go into a sleep mode as the charging transmitter no longer detects the wireless charging receiver. The charging transmitter 21 then begins sniffing or probing to once again detect the receiver coil 24 or the wireless charging receiver 28. Further, in accordance with the exemplary embodiments of the invention, when the device requires charging, it may simply stop sending a “no need to charge” type of signal, or it may send a “charging needed” type of signal.

FIG. 3 illustrates a wireless charging receiver in accordance with the exemplary embodiments of the invention. It will be understood that FIG. 3 can incorporate some similar component circuitry as in the wireless charging system illustrated in FIG. 2, and such similar circuitry is numbered in FIG. 3. However, illustrated in FIG. 3 there is a novel implementation of the charging system which is at least illustrated in Block 30 of FIG. 3, as well as in the modification of the charging interface now shown as USB charging interface 37.

In regards to FIG. 3, in a first aspect of the invention when a “no need to charge” type signal is received from the portable electronic device via the USB charging interface 37 the circuitry of Block 30 completely switches off the power to the wireless receiver block 25. In accordance with the exemplary embodiments, switching off the power includes essentially opening a connection between the receiver coil 24 and the wireless receiver block 25 of the wireless charging receiver. In addition, when the receiver coil 24 of the wireless charging transmitter is open or switched off a wireless charging transmitter 21 which is providing power to the receiver coil 24 is caused to go into a sleep mode mode.

In FIG. 3, the Cfilter 38 filters out fast data communication, for example USB charger detection signal transactions received on at least one of the D+ or D− data lines of the USB charging interface 37. Other signals received on at least one of the D+]or D− data lines such as the “no need to charge” type signals are not filtered by the Cfilter 38. In other words, fast data communication signals may be filtered by the Cfilter 38, whereas slower data communications signals are not filtered. Further, it is noted that the “no need to charge” type signal may be a high impedance signal. Typically, charging detection signaling may operate in the range of 10 milliseconds. However, the filter circuit may use components which operate over a much wider range of speeds in order to prevent missing a charging detection signaling. If the filter circuit reacts slower that the signal is sent it should not be an issue as only a short delay may result in implementing the identified charging operation for the device. For example, the device may remain in a standby mode for a short time longer.

As indicated above, in accordance with the exemplary embodiments of the invention, a “no need to charge” type signal from the portable electronic device can be received over the USB interface data lines of the USB charging interface 37. Also as previously indicated the “no need to charge” type signals are not filtered by the Cfilter 38. Thus, as a result the “no need to charge” type signal can initiate the Block 30 switching off the power being transferred from the receiver coil 24 to the wireless receiver block 25 of the wireless charging receiver. It is noted that, in this case, the charging current to the USB charging interface 37 also disappears. However, the portable electronic device may continue to be attached to the USB charging interface 37 while the power from the receiver coil 24 to the wireless receiver block 25 is switched off.

This aspect of the invention at least enables the wireless charging receiver and a portable device to utilize a particular type of slow data type signal to initiate switching off power to the wireless receiver block 25 when charging current is no longer needed.

It is noted that, according to USB charging specifications, a portable electronic device will know a charge status of its batteries and USB data signaling includes information in this regard. However, the conventional USB data signaling does not support or enable switching off the power from a receiver coil which is being transferred to the wireless receiver block of the wireless charging receiver when charging is no longer needed.

Therefore, these exemplary embodiments alone are seen to reduce the power consumption of the wireless charging receiver to a level lower than the prior art. Further, switching off the power from the receiver coil, or opening the receiver coil circuit, and switching off the power to the receiver block are similar operations. In accordance with the exemplary embodiments of the invention this operation of switching off the power from the receiver coil and/or opening the receiver coil, so that power transferred to another component, for example the wireless receiver block, is performed automatically by the wireless charging receiver itself.

In accordance with the exemplary embodiments of the invention, if charging is again required the portable electronic device may simply stop sending the “no need to charge” type signal or else send a “charging needed” type signal via the data line of the charging interface. As a result the Block 30 will restore the power from the receiver coil 24 to the wireless receiver block 25 and charging of the portable electronic device will occur or resume.

This can occur even if the portable electronic device and the wireless charging receiver remain connected with the wireless charging transmitter since, the connection was opened and the power transfer stopped. This feature is beneficial at least for the reason that it does not require that the charging receiver be removed from the charging transmitter and replaced again to again start charging.

Further, in accordance with the exemplary embodiments of the invention, to create the “no need to charge” type signal at least a part of a USB data signal may be pulled up, raised, adjusted, or modified in some other manner for use by the portable electronic device or the charging receiver to indicate the “no need to charge” type signal. The modified USB signal can then be sent towards the Cfilter 38 of Block 30 if the portable electronic device no longer requires charging. It is noted that the data signaling in accordance with the invention is not limited to USB data signaling but may be performed by different types of charging signaling between a portable electronic device and a charging system. In accordance with the exemplary embodiments of the invention the modified USB data signaling can comprise a modification regarding an enabling of a USB source voltage such as, in a non-limiting example, a VDP UP on the portable device. Such a modification may comprise pulling up or raising the source voltage or a reference voltage in order to create a “no need to charge” type signal or a “charging needed” type of signal or any other signal for use in accordance with the embodiments. As a non-limiting example of a modification in accordance with the exemplary embodiments of the invention, a signal over a USB interface a data node or line, such as D+ (or D− if USB standards allow for it in future) may be modified to be pull-up, such as to 3V/1.5 kΩ. It is noted that the modification of the signal is not limited to pulling up or raising a source voltage of reference voltage. Additionally, modification of a USB data signal can comprise pulling down or lowering a voltage of a signal, such as a signal that was previously pulled up or raised, in order to create a signal for use in accordance with the exemplary embodiments of the invention. Further, as with the USB data signaling as described above, the exemplary embodiments provide that these different types of signaling may be also be pulled up, raised, or modified in some other manner to indicate at least the “no need to charge” type signal of the invention.

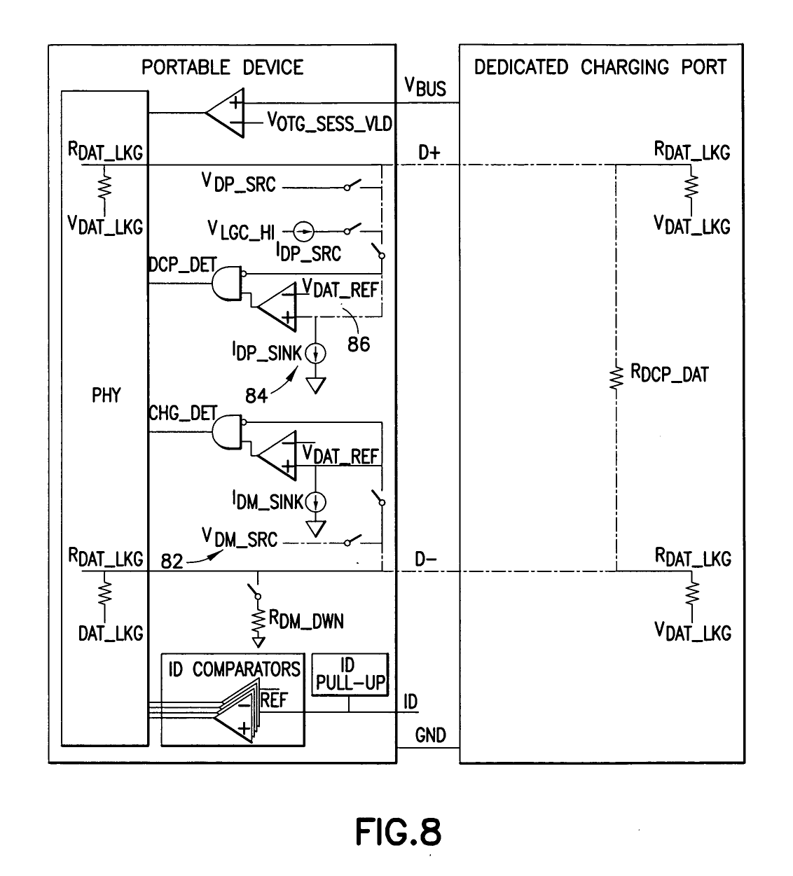

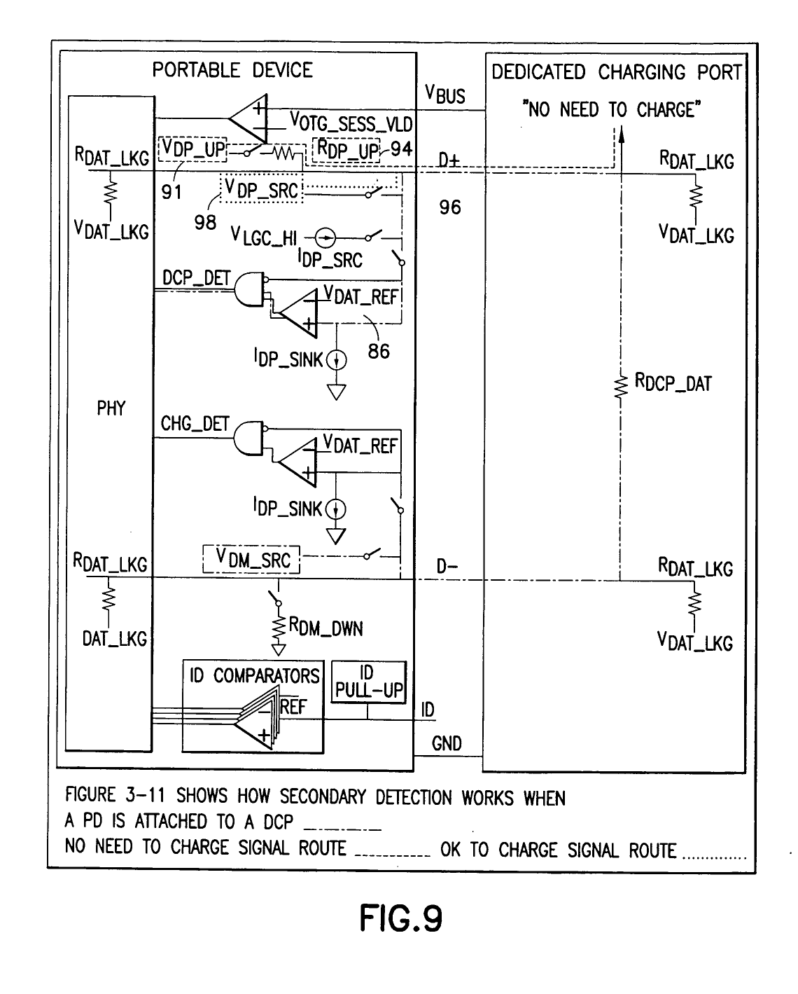

FIG. 8 recreates FIG. 3.11 of USB Battery Charging Specification Revision 1.2. In FIG. 8 there is illustrated at least some of the USB data nodes whose signaling may be modified to create at least the signaling described above for use in accordance with the exemplary embodiments of the invention. FIG. 8 relates to USB secondary detection and dedicated charging port. According to USB Battery Charging Specification Revision 1.2., during secondary detection a portable device shall output a VDM_SRC signal on D− 82, turn on IDP_SINK 84, and compare the voltage on D+ to a VDAT_REF 86. In accordance with the exemplary embodiments, as similarly indicated above, this VDP_UP signal from the portable device or any other signal from the USB signally sources. As illustrated in FIG. 9 modifications are made in order to create a “no need to charge” type signal or a “charging needed” type of signal or any other signal for use in accordance with the exemplary embodiments of the invention.

Additionally, whenever the portable electronic device sees a charging voltage on the charging interface 37 the device begins charger detection and charging accordingly. This is particularly desirable if the charging receiver and the portable electronic device is removed and then another, different, device is connected to the charging interface. Further, it is noted that the charging interface may be a type of direct current (DC) socket. It is noted that when the device is removed from transmitter it may keep the “no need to charge” high impedance signal up as long as battery is full since this signal consumes minimal power. When a battery of the device is in a dead battery state the data line will be down and, as a result, the wireless charging receiver or the sleeve will automatically start providing charging current to the device.

Further, in regards to FIG. 3, in another aspect of the invention the Cstart 39 acts to retain the status of the wireless charging receiver after the wireless charging receiver is taken away from the wireless charging transmitter, such as being removed from the magnetic field of the wireless charging transmitter or transmitter coil. As an example, the wireless charging transmitter can be a charging plate. If the power from the receiver coil of the wireless charging receiver was switched off and/or the receiver coil was opened prior to the wireless charging receiver being taken away from the charging plate then the components of the wireless charging receiver will maintain that the receiver coil is switched off even after being taken away. Therefore, in accordance with the exemplary embodiments of the invention, the wireless charging receiver will not begin to conduct power through its circuitry again once taken away and thus will not draw further power from the battery of the device to which it is attached. Further, if the wireless charging receiver is returned to the plate or the electro magnetic energy field of the wireless charging transmitter then the power to the wireless receiver block may be switched on and the portable electronic device may resume charging.

If some other interface, such as other than a USB charging interface, is used on the device as the charging interface for the device then additional contacts, as needed, can be arranged between wireless charging receiver or sleeve and the different charging interface of the portable electronic device. Further, if a contact for the data signaling is not available between the portable electronic device and the wireless charging receiver or sleeve, then another type of wireless communication, such as a near field communication, could used for the data signaling. Further, the data signaling can be sent by various means via the charging interface or even wirelessly.

In addition, the “no need to charge” type signaling could also be used for reducing standby power in different types of wired or wireless charging systems. It can be seen that such an implementation of the exemplary embodiments may be advantageously included in a standard for interoperability between the different types of wired or wireless charging systems and portable devices. Further, to support full compatibility with a different type of charging system the charging receiver or sleeve may be modified electrically and/or mechanically to interface with any electronic device. Additionally, the exemplary embodiments of the invention can be performed with circuitry and/or other types of circuitry integrated into the electronic device themselves using internal or external contacts or a combination of both.

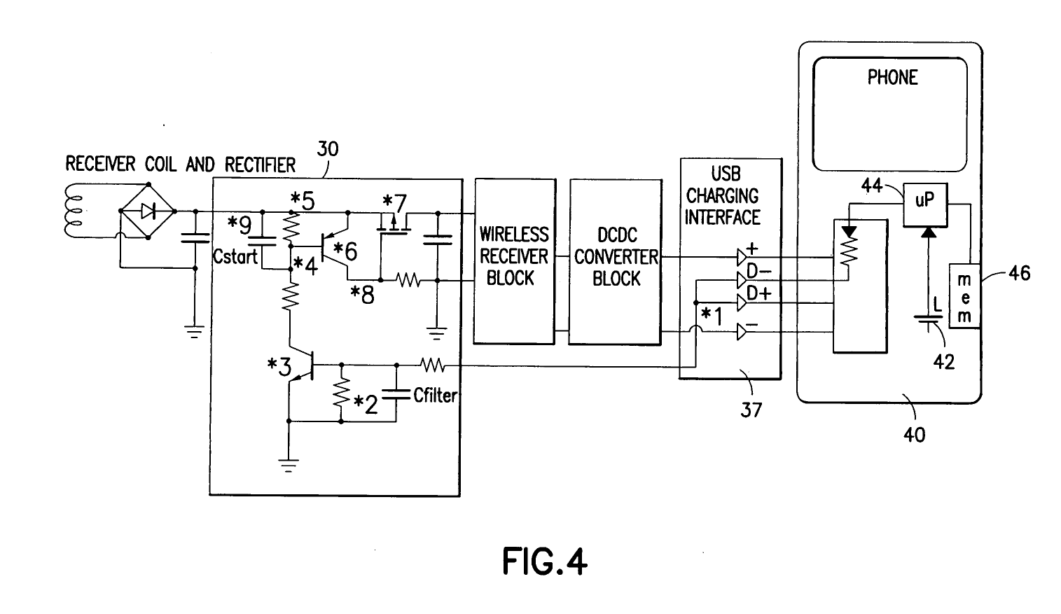

Regarding FIG. 4, the operations of the wireless charging receiver and the portable electronic device are described in more detail. In this non-limiting example a phone 40 is illustrated to represent the portable electronic device. The phone 40 includes a battery 42 and a controller such as a microprocessor 44 connected to the USB charging interface 37. Further, the microprocessor 44 is connected to a memory 46. The memory 46 can be any suitable non-transitory computer readable medium, and is at least for use by the microprocessor 44 to store and execute instructions to perform operations in accordance with the exemplary embodiments of the invention.

In regards to FIG. 4, the following is a brief explanation of the logic in accordance with the exemplary embodiments of the invention:

When the Portable Electronic Device Requires Charging:
for example when a “no need to charge” type signal is no longer received from the device or “charging needed” type signal is received from device;
The portable electronic device sets the data line D+*1 to VDP_SRC;
The NPN transistor*3 does not conduct;
The voltages at nodes *4 and *5 are set to equal;
The PNP transistor *6 does not conduct; and
The voltage at node *8 is set to 0V.
   The result is that P-channel Field Effect transistor (FET) *7 has a negative Gate (G) to Source (S) voltage (node *5 is higher than node *8) and the FET *7 will conduct. Therefore the receiver coil 24 is connected to the wireless receiver block.

When the Portable Electronic Device Does not Require Charging
for example when a “no need to charge” type signal is received from the device:
The portable electronic device sets the data line D+*1 to VDP_UP;
The NPN transistor *3 conducts;
The voltage on node *5 is set higher than the voltage on node *4;
The PNP *6 conducts; and
Voltage on node *8 is set equal to the voltage on node *5.
   The result is that the P-channel FET *7 has no G to S voltage difference and the FET *7 will not conduct, thus the power to the wireless receiver block is switched off (e.g., the power link from the receiver coil 24 to the wireless receiver block is opened).

As indicated above, the P-channel FET *7 acts as a switch. Cfilter *2 may not be involved in this operation, as Cfilter *2 may only filter out fast data communication (USB charger detection transactions on the data line *1). Slow actions or signals on data line *1 may not be filtered, meaning the “no need to charge” type signal is not affected by Cfilter*2. Also, as similarly stated earlier, Cstart *9 functions as a memory of the situation before removing the device from transmitter plate. Therefore, if the device is removed during charging, Cstart *9 may carry no potential difference on its leads. This means that NPN transistor *6 is conducting and P-channel FET transistor *7 will conduct as soon as there is voltage on the source. Further, if the device is removed when not charging=>NPN *6 is off=>FET *7 will not conduct. In addition, the Cstart *9 functions will also provide additional benefit such as when the device is kept out of an electro magnetic energy field of the charging transmitter and the wireless charging receiver had already been switched off in response to the “no need to charge” type signal, and the battery power of the portable device full. In this situation, without the Cstart *9 at least a display of the portable device may remain powered down to the user. However, in accordance with an exemplary embodiment of the invention, as the Cstart *9 would also be at zero voltage the Cstart would cause the charging interface and at least the display of the portable device to wake up. Thereby enabling the device to be fully active. In regards to at least FIG. 4, it is noted that the identifier *1 can represent any one of the +, D−, D+, or − data lines or nodes as well as a combination of one or more of these data lines or nodes. Further, any one of the + or − data lines or nodes can represent a VBUS, as is illustrated in FIG. 8.

It can be seen that the exemplary embodiments improve control of the wireless charging receiver and the wireless charging transmitter so that power utilization by the wireless charging system is at a minimum level when a device is no longer accepting a charge and if the device and the charging receiver is removed from the charging transmitter. This is made apparent from the following examples:

### EXAMPLE #1

### Conventional Wireless Charging System Power Usage

Power taken from mains 230V
   Standby 160 mW
   Charging 7.5 W
   After charging 0.92 W
Power to transmitter
   Standby 19V/0.5 mA=8 mW
   Charging 19V×323 mA=6.1 W
   After charging 19V×33 mA=0.63 W
Power to phone
   4.91V×900 mA=4.4 W
Wall adapter 7.5 W eff. 0.81
Transmitter+Receiver+DC−DC 6.1 W Eff. 0.72
Phone charging 4.4 W, Total transfer Eff. 0.59

### EXAMPLE #2

### Wireless Charging System Power Usage in Accordance with the Exemplary Embodiments of the Invention

Power taken from mains 230V
   Standby 140 mW
   Charging 7.66 W
   After charging 0.88 W
Power to transmitter
   Standby 19V/0.46 mA=8.74 mW
   Charging 19V×325 mA=6.175 W typical
   Charging 19V×354 mA=6.726 W max. detected
   After charging 19V×32 mA=0.608 W
Power to phone
   4.996V×885 mA=4.421 W
Wall adapter 7.66 W eff. 0.806
Transmitter+Receiver+DC−DC 6.175 W Eff. 0.716
Phone charging 4.42 W, Total transfer Eff. 0.577

It can be seen that in Example #1 the standby power is 160 mW after charging 920 mW. Whereas in Example #2 the standby power used is substantially less (140 mW after charging 880 mW). The exemplary embodiments of the invention provide a clear improvement over conventional charging systems.

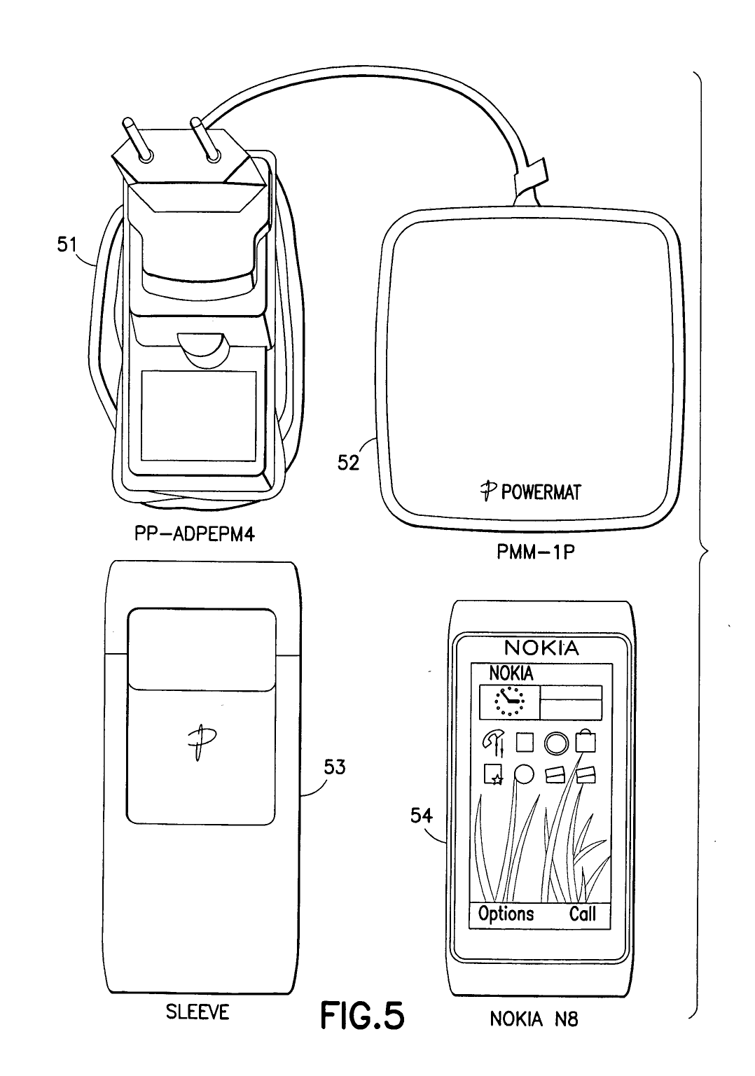

FIG. 5 is non-limiting and illustrates a pictorial view of a wireless charging transmitter power source 51 and the wireless charging transmitter 52. In addition, in FIG. 5 there is illustrated a wireless charging receiver sleeve 53 and a portable electronic device 54 (e.g., a cellular phone).

In addition, in accordance with the exemplary embodiments of the invention, a device, such as a portable electronic device can be provided with the necessary functionality to determine a need to send a “no need to charge” type signal and to create the signal. Further, in accordance with the exemplary embodiments of the invention the device may be provided with an ability to modify or manipulate any type of data signal, including a USB type data signal, to create or maintain a “no need to charge” type signal. These embodiments include, but are not limited to, that the device can modify at least part of a waveform of any existing signal, such as a USB data transaction signal. Further, any of these operations may be performed with internal circuitry and/or software internal to or external to the device.

FIG. 9 also recreates FIG. 3.11 of USB Battery Charging Specification Revision 1.2., similar to FIG. 8. FIG. 9 additionally incorporates signaling in accordance with the exemplary embodiments of the invention. In accordance with the exemplary embodiments of the invention, D+ (96) signaling is used for the “No need to charge” type signal. This is so that VDP UP (91) 3.0V is supplied via RDP_UP (94) 1.5 kΩ. When charging is allowed, such as indicated by the “charging needed” type of signal, only low voltage VDP_SRC (98) is present and so the charging transmitter, such as the sleeve, becomes active again. One of these signals should be present after secondary detection detects a dedicated charging port. This D+ (96) signaling, in accordance with the exemplary embodiments, ensures that USB compliance testing will pass in all cases, such as when a portable device dedicated charging port is tested alone.

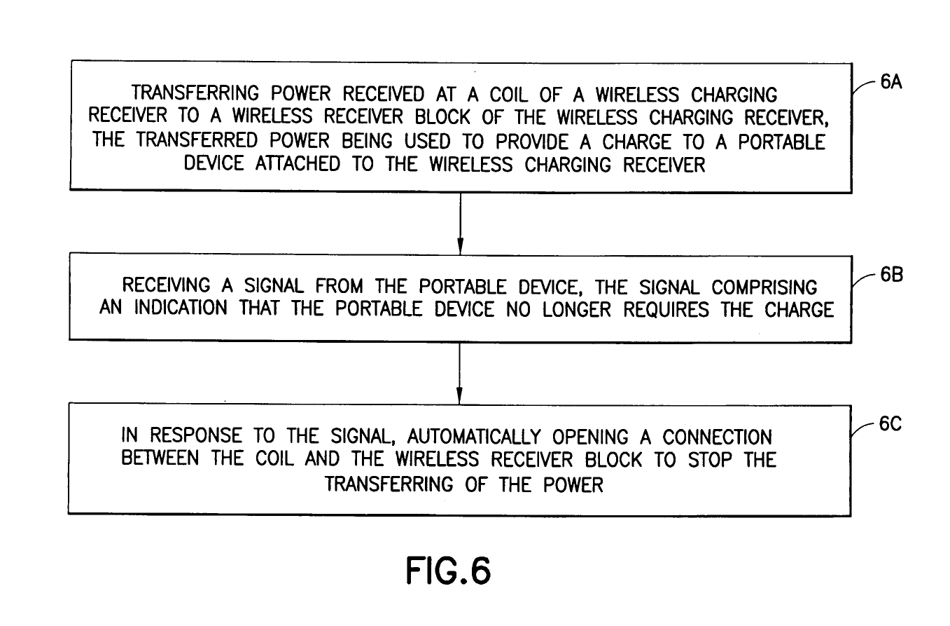

FIG. 6 is a logic flow diagram that illustrates the operation of a method, and a result of execution of computer program instructions, further in accordance with the exemplary embodiments of this invention. In accordance with these exemplary embodiments a method performs, at Block 6A, there is a step of transferring power received at a coil of a wireless charging receiver to a wireless receiver block of the wireless charging receiver, the transferred power being used to provide a charge to a portable device attached to the wireless charging receiver. At Block 6B there is a step of receiving a signal from the portable device, the signal comprising an indication that the portable device no longer requires the charge. At Block 6C there is a step, in response to the signal, of automatically opening a connection between the coil and the wireless receiver block to stop the transferring of the power.

In accordance with the method shown in FIG. 6, where the signal is received via a data node of a charging interface between the wireless charging receiver and the portable device.

In accordance with the method shown in FIG. 6, where the wireless charging receiver and the portable device are attached with a universal serial bus charging interface and where the signal is a universal serial bus data signal received over a data node of the universal serial bus charging interface.

Further, in accordance with the paragraph above, the modified universal serial bus data signal is modified to produce a continuous signal received over the data node while the portable device no longer requires the charge

In accordance with the method shown in FIG. 6, the signal is received continuously while the portable device no longer requires the charge.

Further, in accordance with the paragraph above, the portable device remains attached to the wireless charging receiver after the transferring of the power from the coil to the wireless receiver block is stopped.

Further, in accordance with the paragraph above, the method shown in FIG. 6 further comprising while the portable device remains attached, in response to one of no longer receiving the signal continuously or receiving a charge request type signal from the portable device closing the connection and resuming the transferring of the power from the coil to the wireless receiver block; and providing the charge to the portable device.

In accordance with the method shown in FIG. 6, the coil is receiving the power from a magnetic field of a charging transmitter and where after the coil is removed from the field the connection between the between the coil and the wireless receiver block remains open until the coil is returned to the field.

In accordance with the method shown in FIG. 6, the wireless charging receiver comprises a sleeve designed for the portable device.

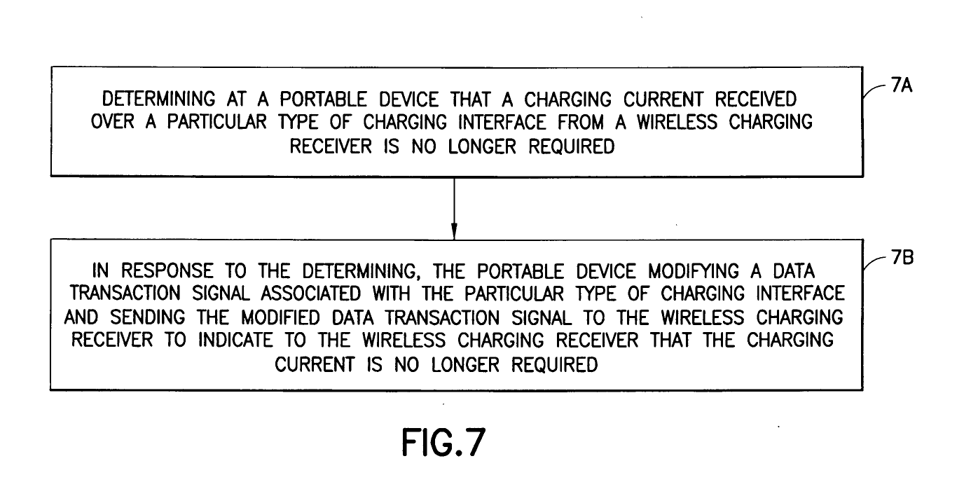

FIG. 7 is a logic flow diagram that illustrates the operation of a method, and a result of execution of computer program instructions, further in accordance with the exemplary embodiments of this invention. In accordance with these exemplary embodiments a method performs, at Block 7A, a step of determining at a portable device that a charging current received over a particular type of charging interface from a wireless charging receiver is no longer required. At Block 7B there is a step of, in response to the determining, the portable device modifying a data transaction signal associated with the particular type of charging interface and sending the modified data transaction signal to the wireless charging receiver to indicate to the wireless charging receiver that the charging current is no longer required.

In accordance with the method shown in FIG. 7, the particular type of charging interface is a universal serial bus charging interface, where the modified data transaction signal is a modified universal serial bus data signal sent via a data node of the universal serial bus charging interface.

Further, in accordance with the paragraph above, the modified universal serial bus data signal is indicating a continuous signal sent via the data node while the charging current is no longer required.

In accordance with the method shown in FIG. 7, the signal causes the wireless charging receiver to automatically open a connection and stop a transfer of power between a coil and a wireless receiver block of the wireless charging receiver.

The various steps and operations recited above with respect to FIG. 6 are applicable as well to the embodiment shown in FIG. 7.

The various blocks shown in FIGS. 6 and 7 may be viewed as method steps, and/or as operations that result from operation of computer program code, and/or as a plurality of coupled logic circuit elements constructed to carry out the associated function(s).

Embodiments of this invention may be implemented in a device or devices by hardware circuitry such as integrated circuitry and/or other circuitry, by computer software executable by hardware circuitry, or by a combination of software and hardware circuitry. Further in this regard it should be noted that the various blocks of the logic flow diagram of FIG. 6 and FIG. 7 may represent interconnected logic circuits, blocks, functions, program steps, or a combination of logic circuits, blocks, functions, and program steps for performing the specified tasks.

In general, the device, such at the portable electronic device, may have wireless capabilities and the various embodiments of the device can include, but are not limited to, cellular telephones, personal digital assistants (PDAs), portable computers, image capture devices such as digital cameras, gaming devices, music storage and playback appliances, Internet appliances permitting Internet access and browsing, as well as portable units or terminals that incorporate combinations of such functions.

The memory or memories of the device implementing the embodiments of the invention may be of any type suitable to the local technical environment and may be implemented using any suitable data storage technology, such as semiconductor-based memory devices, magnetic memory devices and systems, optical memory devices and systems, fixed memory and removable memory. The data processor[s] of the device or charging system may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Still further, the various names and parameters used for the contacts of the charging interface, for the different types of signaling, and for the components which enable any exemplary embodiments of this invention are not intended to be limiting in any respect, as these names and parameters may be identified by any suitable name or parameter.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, any of the features of any exemplary embodiments of this invention as described above could be used to advantage without the corresponding use of other features. As such, the foregoing description should be considered as merely illustrative of the principles of the invention, and not in limitation thereof.

What is claimed is:

1. A method comprising:
transferring power received at a coil of a wireless charging receiver to a wireless receiver block of the wireless charging receiver, the transferred power being used to provide a charge to a portable device attached to the wireless charging receiver;
receiving a signal from the portable device, the signal comprising an indication that the portable device no longer requires the charge; and
in response to the signal, automatically opening a connection between the coil and the wireless receiver block to stop the transferring of the power.

2. The method of claim 1, where the wireless charging receiver and the portable device are attached with a universal serial bus charging interface and where the signal is a modified universal serial bus data signal received over a data node of the universal serial bus charging interface.

3. The method of claim 2, where the modified universal serial bus data signal is modified to be a continuous signal received over the data node while the portable device no longer requires the charge.

4. The method of claim 1, where the portable device remains attached to the wireless charging receiver after the transferring of the power from the coil to the wireless receiver block is stopped; further comprising:
while the portable device remains attached, in response to one of no longer receiving the signal continuously or receiving a charge request type signal from the portable device closing the connection and resuming the transferring of the power from the coil to the wireless receiver block; and
providing the charge to the portable device.

5. The method of claim 1, where the coil is receiving the power from a magnetic field of a charging transmitter and where after the coil is removed from the field the connection between the coil and the wireless receiver block remains open until the coil is returned to the field.

6. A non-transitory computer readable medium embodying a computer program, executable by at least one processor, to perform the method of claim 1.

7. An apparatus comprising:
at least one processor; and
at least one memory including computer program code, where the at least one memory and the computer program code are configured, with the at least one processor, to cause the apparatus to at least:
transfer power received at a coil of a wireless charging receiver to a wireless receiver block of the wireless charging receiver, the transferred power being used to charge a portable device attached to the wireless charging receiver;
receive a signal from the portable device, the signal comprising an indication that the portable device no longer requires the charge; and
in response to the signal, automatically open a connection between the coil and the wireless receiver block to stop the transferring of the power.

8. The apparatus of claim 7, where the wireless charging receiver and the portable device are attached with a universal serial bus charging interface and where the signal is a modified universal serial bus data signal received over a data node of the universal serial bus charging interface.

9. The apparatus of claim 8, where the modified universal serial bus data signal is modified to be a continuous signal received over the data node while the portable device no longer requires the charge.

10. The apparatus of claim 7, where the portable device remains attached to the wireless charging receiver after the transferring of the power from the coil to the wireless receiver block is stopped; further comprising:
the at least one memory including computer program code are configured, with the at least one processor, while the portable device remains attached, to in response to one of no longer receiving the signal continuously or receiving a charge request type signal from the portable device close the connection and resume the transferring of the power from the coil to the wireless receiver block; and
provide the charge to the portable device.

11. The apparatus of claim 7, where the coil is receiving the power from a magnetic field of a charging transmitter and where after the coil is removed from the field the connection between the between the coil and the wireless receiver block remains open until the coil is returned to the field.

12. The apparatus of claim 7 comprising a sleeve designed for the portable device.

13. A method comprising:
determining at a portable device that a charging current received over a particular type of charging interface from a wireless charging receiver is no longer required; and
in response to the determining, the portable device modifying a data transaction signal associated with the particular type of charging interface and sending the modified data transaction signal to the wireless charging receiver to indicate to the wireless charging receiver that the charging current is no longer required.

14. The method of claim 13, where the particular type of charging interface is a universal serial bus charging interface, where the modified data transaction signal is a modified universal serial bus data signal sent via a data node of the universal serial bus charging interface.

15. The method of claim 14, where the modified universal serial bus data signal is a modified to be a continuous signal sent via the data node while the charging current is no longer required.

16. The method of claim 13, where the signal causes the wireless charging receiver to automatically open a connection and stop a transfer of power between a coil and a wireless receiver block of the wireless charging receiver.

17. A non-transitory computer readable medium embodying a computer program, executable by at least one processor, to perform the method of claim 13.

18. An apparatus comprising:
at least one processor; and
at least one memory including computer program code, where the at least one memory and the computer program code are configured, with the at least one processor, to cause the apparatus to at least:
determine at a portable device that a charging current received over a particular type of charging interface from a wireless charging receiver is no longer required; and
in response to the determining, modify a data transaction signal associated with the particular type of charging interface and send the modified data transaction signal to the wireless charging receiver to indicate to the wireless charging receiver that the charging current is no longer required.

19. The apparatus of claim 18, where the particular type of charging interface is a universal serial bus charging interface, where the modified data transaction signal is a modified universal serial bus data signal sent via a data node of the universal serial bus charging interface.

20. The apparatus of claim 18, where the signal causes the wireless charging receiver to automatically open a connection and stop a transfer of power between a coil and a wireless receiver block of the wireless charging receiver.
